(19) United States
(12) Patent Application Publication
(10) Pub. No.: US 2013/0297552 A1
(43) Pub. Date: Nov. 7, 2013

(54) METHOD OF EXTRACTING KNOWLEDGE RELATING TO A NODE IN A DISTRIBUTED NETWORK

(71) Applicant: WHISTLE TALK TECHNOLOGIES PRIVATE LIMITED, Bangalore (IN)

(72) Inventor: Ashish BANSAL, Gwalior (IN)

(21) Appl. No.: 13/875,826

(22) Filed: May 2, 2013

(30) Foreign Application Priority Data
May 2, 2012 (IN) 3761/CHE/2011

(51) Int. Cl. G06N 5/02

(52) U.S. Cl. CPC G06N 5/02
USPC 706/50

(57) ABSTRACT

Embodiment is related to a method of extracting knowledge relating to a node from a plurality of nodes in a distributed network. Firstly, acquiring expertise information of each of plurality of nodes connected to distributed network. The expertise information is acquired by a mode comprising inputting, importing and learning by plurality of nodes. Next, a network power of a node from plurality of nodes is computed based on plurality of nodes connected to node. The network power is based on expertise information of plurality of nodes connected to node. Thirdly, a contribution score of the node from plurality of nodes is measured based on role of node towards one or more transactions in distributed network. Lastly, a reputation score of node is determined using at least one of the acquired expertise information, computed network power and measured contribution score for extracting knowledge relating to node in distributed network.

### TECHNICAL FIELD

Embodiments of the present disclosure relate to determine reputation of a node in a distributed network. More particularly, the embodiment of the present disclosure is related to a method of extracting knowledge of the node for determining reputation of the node in the distributed network.

### BACKGROUND

One important emerging class of problems in connected networks involves relying on expertise of individual nodes to find responses to specific information needs, Within this context, one can assume that any two nodes, for example people, in a connected network are connected by one or more paths, a concept similar to “six degrees of separation” property. Moreover, expertise tends to be distributed throughout a connected network such that, for any information need, there are one or more nodes within the network for which, partial or full answer to the query is easily at-hand. Thus, in general, there exists, for most queries, one or more nodes at varying distances from the query originator node, which has full or partial answer to the query. The problem, however, is that while a path to a query's answer node(s) may exist within the connected network, that path is typically hard to identify. Moreover, individual nodes in the network do not have a mechanism to identify, capture and publish the nodes implicit and explicit expertise, which is constantly evolving, due to continuous learning by individual nodes.

In general, a user creates an individual profile and establishes a network of various members in a distributed network. The profile of each member connected to the user can include information such as name, age, address, events/activities the member is involved into, interests the member has on, photographs and other related information of the member. In conventional reputation systems, a reputation of the user is estimated based on the number of connections the user has with the network of members.

Further, conventional reputation systems rely on user-assigned scores to judge on other member legitimate behaviour. For example, a buyer in an online auction system may use the seller's score of the reputation system to judge whether the seller is trustworthy. However, a serious problem of existing reputation systems is the simplicity to create a highly trustworthy score by a seller himself or a seller's friend, or vice versa, create an untrustworthy score for a competitor. Therefore, the conventional reputation system lacks in estimating the reputation of the node based on the connections and profile information of other nodes connected to the node in the distributed network.

Hence, there is a need to provide a method and a system to determine reputation of a user based on the profile information of other members connected to the user in the distributed network.

### SUMMARY

The shortcomings of the prior art are overcome through the provision of a method and a system as described in the description.

The present disclosure is related to determine reputation of a node in a distributed network. More particularly, the present disclosure provides a method of extracting knowledge relating to the node from a plurality of nodes in the distributed network. The method comprises steps of acquiring, by a processor, an expertise information of each of the plurality of nodes connected to the distributed network. In an embodiment, the expertise information is acquired by a mode comprising inputting, importing and learning by the plurality of nodes. Next, a network power of a node from the plurality of nodes is computed by the processor which is based on the plurality of nodes connected to the node. The network power is based on the expertise information of the plurality of nodes connected to the node. Later, a contribution score of the node from the plurality of nodes is measured, wherein the contribution score is based on role of the node towards one or more transactions in the distributed network. Lastly, a reputation score of the node is determined using at least one of the acquired expertise information, the computed network power and the measured contribution score for extracting knowledge relating to the node in the distributed network.

The present disclosure provides a system for extracting knowledge relating to a node from a plurality of nodes in a distributed network. The system comprises a server and a computing device. The server comprises a processor configured in it and a memory unit is coupled to the processor. The processor is configured to acquire expertise information of each of the plurality of nodes connected to the distributed network. In an embodiment, the expertise information is acquired by a mode comprising inputting, importing and learning by the plurality of nodes. Each of the plurality of nodes is associated with a computing device which is configured to receive the expertise information inputted by the plurality of nodes. Next, the processor computes a network power of a node from the plurality of nodes based on the plurality of nodes connected to the node. The network power is based on the expertise information of the plurality of nodes connected to the node. Then, a contribution score of the node from the plurality of nodes is measured by the processor which is based on role of the node towards one or more transactions in the distributed network. Lastly, a reputation score of the node is determined by the processor using at least one of the acquired expertise information, the computed network power and the measured contribution score for extracting knowledge relating to the node in the distributed network. The memory unit is configured to store the acquired expertise information, computed network power, measured contribution score and the determined reputation score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The features of the present disclosure are set forth with particularity in the appended claims. The disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates a distributed network with a plurality of nodes and a server in accordance with an embodiment of the present disclosure;

FIG. 2 illustrates an exemplary system for extracting knowledge relating to a node in the distributed network in accordance with an embodiment of the present disclosure;

FIG. 3 illustrates an exemplary method of extracting knowledge relating to the node in the distributed network in accordance with an embodiment of the present disclosure; and

FIG. 4 illustrates evolving roles of nodes in the distributed network in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

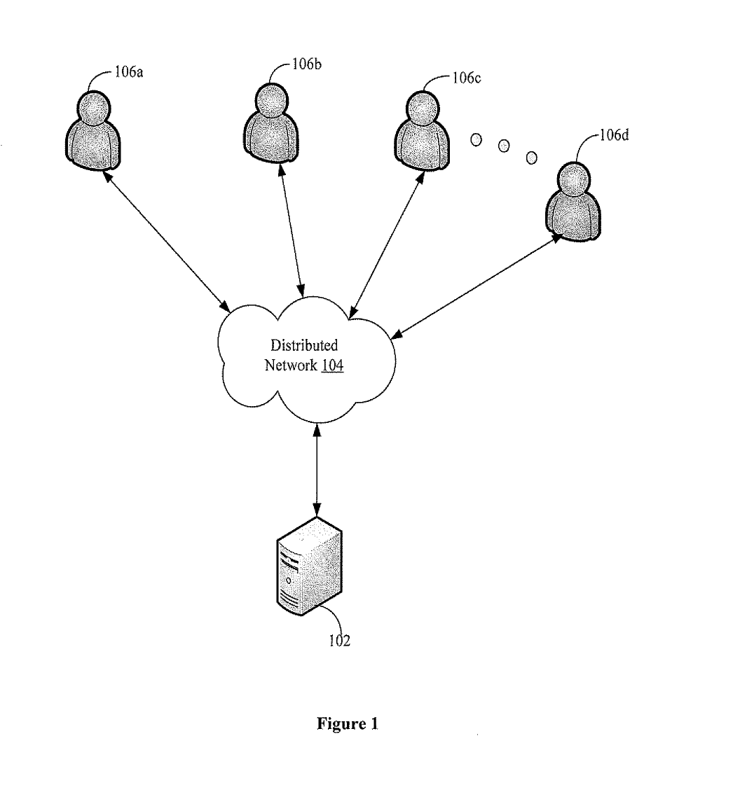

FIG. 1 illustrates a distributed network 104 with a plurality of nodes (106a, 106b, 106c, and 106d, collectively referred to as 106) and a server 102 in accordance with an embodiment of the present disclosure. The distributed network 104 includes but is not limited to an e-commerce network, an information portal, social network, address book, contact list, interest group, and a peer to peer (P2P) network. As an example, only four nodes are illustrated in the distributed network 104. However, a person skilled in the art would understand that any number of nodes could be used with the network of the present disclosure. In an embodiment, the plurality of nodes 106 which include, but not limited to, at least one of a person, a user, a member, a candidate and an entity connected in the distributed network 104. Each node among the plurality of nodes 106 is peer-peer nodes participating in a peer-to-peer networking environment. In an embodiment, the peer-to-peer networking environment includes extracting or using an expertise information for performing one or more transactions. For example, a node 106a has peer-to-peer networking environment with other nodes 106b, 106c, and 106d i.e. the node 106a extracts the expertise information of other nodes 106b, 106c, and 106d. Similarly, the node 106b has peer-to-peer networking environment with other nodes 106a, 106c, and 106d. Each node in the plurality of nodes 106 is associated with a computing device for interacting with the server 102 in the distributed network 104.

The server 102 connected to the plurality of nodes 106 over the distributed network 104 is involved in extracting the knowledge of the plurality of nodes 106 for determining a reputation score of each of the plurality of nodes 106. The objective of determining the reputation score of each of the plurality of nodes 106 is to perform one or more transactions in the distributed network 104 based on the expertise information. In an embodiment, the one or more transactions includes but not limited to request for a job, request for finding a right candidate, request for finding a full or partial answer to a query, request for improving previously found knowledge, request for recommendations, request for directions and other like recommendations and requirements.

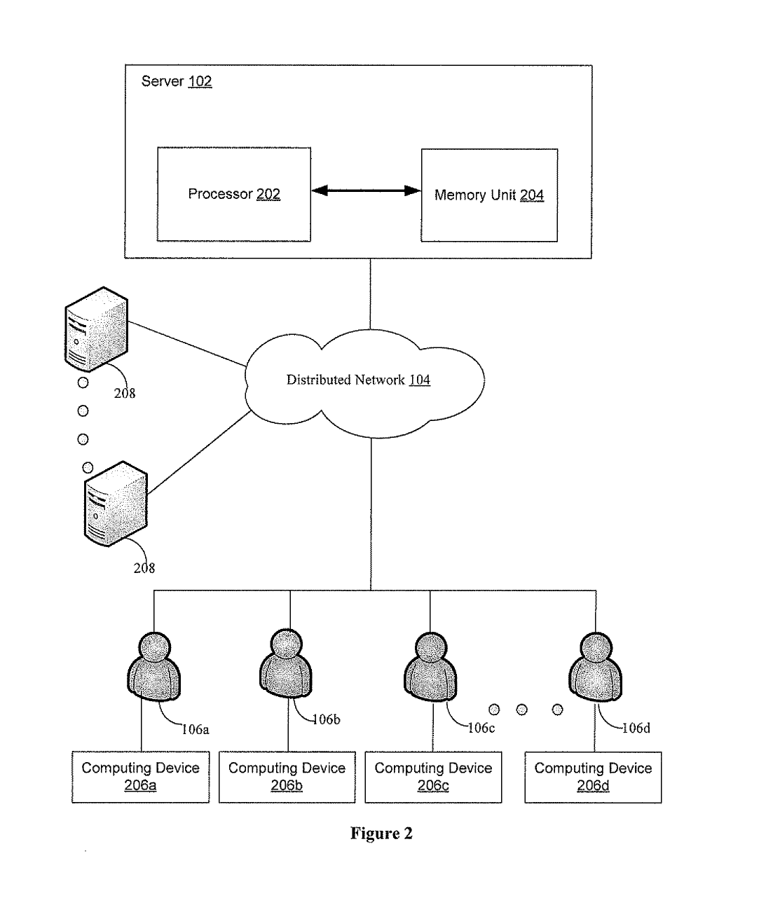

FIG. 2 illustrates an exemplary system for extracting knowledge relating to a node from the plurality of nodes 106 in the distributed network 104 in accordance with an embodiment of the present disclosure. In an embodiment, the distributed network 104 is connected to a plurality of social network servers 208, for example, social network servers 208 includes but not limited to Google+®, LinkedIn®, Facebook®, Twitter® and other social network servers 208. The system comprises a server 102 and a computing device (206a, 206b, 206c and 206d, collectively referred to as 206) associated to respective plurality of nodes 106 in the distributed network 104. For example, the computing device 206a is associated to the node 106a, the computing device 206b is associated to the node 106b and so on. Each of the computing devices 206 is selected from at least one of a laptop, a desktop, a mobile phone, a Personal Digital Assistants (PDA). A person skilled in the art would understand that any device capable of performing data transmission and displaying can be used with the present disclosure. The server 102 comprises a processor 202 and a memory unit 204. The processor 202 is configured to acquire expertise information of each of the plurality of nodes 106 connected to the distributed network 104. The expertise information of the plurality of nodes 106 is selected from a group comprising name, social contacts, address, qualifications, education, events, activities, interests, designations, type or class of messages transacted and one or more of the parameters directly or indirectly associated with each of the messages.

In an embodiment, the expertise information is acquired by a mode including but is not limited to inputting, importing and learning by each of the plurality of nodes 106 on the respective computing device 206. For example, the expertise information is learned by the processor 202 and stored in memory unity 204 based on the interactions of each node with each other and with message transactions. Similarly, the processor 202 can import the expertise information based on the interaction of each node with other nodes. The expertise information of the plurality of nodes 106 in the distributed network 104 is updated by the user regularly, For example, if the node 106a updates the education information like the node 106a′s interest is “JavaScript” then the updating the education information becomes the expertise information which is then acquired by the processor 202. Similarly, the node 106b giving a rating score to a restaurant say “xyz” becomes the expertise information. In an embodiment, the expertise information of each of the plurality of nodes 106 can be imported from the server 102 and the social network servers 208.

The processor 202 computes a network power of a node from the plurality of nodes 106 which is based on the plurality of nodes 106 connected to the node. The network power is computed to find a response to a message by utilizing the expertize of nodes directly or indirectly connected to it. For example, computing the network power of the node 106a is based on the number of other nodes connected to the node 106a either directly or indirectly. Particularly, the node 106a is connected to nodes 106b, 106c and 106d directly, then the network power of the node 106a is based on the nodes 106b, 106c and 106d. Similarly, if node 106e is connected to nodes such as 106e, 106f, 106g (not shown in the Figures) which is in turn connected to node 106h (not shown in the Figures), then overall network power of the node 106a in a peer-peer network environment, connected indirectly nodes 106e, 106f, 106g and 106h, is computed based on the nodes 106c, 106e, 106f, 106g and 106h. The network power is based on the expertise information of the plurality of nodes 106 connected to the node. That is, the network power is based on how well the node accesses or extracts or uses the expertise information of other nodes in the distributed network 104 for performing one or more transactions. For example, the network power of node 106a is based on the expertise information of other nodes 106b, 106c and 106d so that there exists the peer-peer network environment for performing one or more transactions through node 106a. In an embodiment, the one or more transaction includes but not limited to request for a job, request for finding a right candidate, request for finding a full or partial answer to a query, request for improving previously found knowledge, request for recommendations, request for directions and other like recommendations and requirements.

The one or more transactions can be initiated by either server 102 or any one of the plurality of nodes 106. For example, the server 102 can post a job opening and initiate request to find a right candidate to the plurality of nodes 106 based on the expertise information of the plurality of nodes 106. The processor 202 can recommend to node 106a and a set of nodes reachable through node 106a, that matches the requirements of the job posting. In processing the information, node 106a can forward the job posting to the recommended list or choose another subset of connected nodes (like 106b, 106c and 106d) to send the job requirements forward. The recommendation by process 202 is based on the reputation information of the nodes 106b, 106c and 106d satisfying partially or fully the descriptions of the job hiring requirements. If node 106b, satisfying the description of the job hiring requirements partially, can recommend the job hiring requirement to its other connected nodes like 106f, 106g which in turn recommends to node 106h until the descriptions of the job hiring requirements is satisfied fully.

A contribution score of the node from the plurality of nodes 106 is measured by the processor 202. The contribution score measures the demonstrated intent of a node to contribute towards finding a response to one or more transactions in the distributed network 104. The contribution score is based on how well a node in the distributed network 104 interacts with other nodes and receives a reply or responses for a query message to complete a transaction successfully. For example, contribution score of node 106a is measured based on including but not limited on kind of transactions with other nodes 106b, 106c and 106d and the responses the node 106a received from other nodes 106b, 106c and 106d based on the expertise information satisfying the query message partially or fully.

The processor 202 determines a reputation score of the node using at least one of the acquired expertise information, the computed network power and the measured contribution score for extracting knowledge relating to the node in the distributed network 104. For example, the reputation score of node 106a is determined using the expertise information, network power and contribution score. The memory unit 204, coupled to the processor 202, is configured to store the acquired expertise information, computed network power, measured contribution score and the determined reputation score. The memory unit 204 includes but not limited to a computer readable media having executable instructions. Such computer readable media can be any available media which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or network attached storage, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

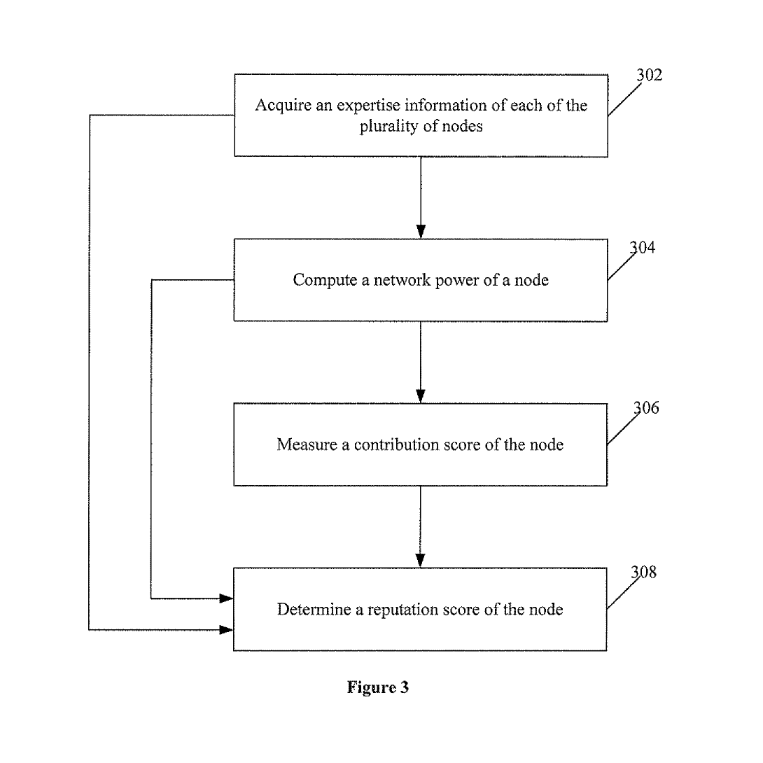

FIG. 3 illustrates an exemplary method of extracting knowledge relating to the node from the plurality of nodes 106 in the distributed network 104 in accordance with an embodiment of the present disclosure. In an embodiment, initially when a node is newly registered with the server 102 or referred for first time by the server 102, then an expertise, a network power and a contribution score of the node are set to an initial value. The recommendation or one or more transaction to be performed by or through the node depends on the set initial value. For example, given a message, the recommendation of the given message to a source node and all other nodes reachable through the source node is based on the initial value of the source node. Once the nodes start handling messages or answering messages, their expertise, network power and contribution score is increased gradually. The reputation score for each node is computed as a weighted sum of each of expertise, network power and contribution score. In one exemplary embodiment, the reputation score is a sum of 30% of network power, 30% of contribution quotient and 40% of expertise.

At step 302, the processor 202 configured in the server 102 acquires an expertise information of each of the plurality of nodes 106a. The plurality of nodes 106 is connected to the server 102 either by registering with the server 102 and configuration i.e. an administrator creates a new node by configuration. Each node when registered or configured newly with the server 102 has its expertise, network power and contribution score set to an initial value. During the registration or configuration, a node from the plurality of nodes 106 list down its expertise information. For example, when a node is a person connected to the server 102, the person's expertise information is listed down. The expertise information can be imported from social network serves 208 to which the person is connected.

In an embodiment, the expertise information is acquired by a mode comprising inputting, importing and learning by the plurality of nodes 106. For example, the expertise information is learned by the processor 202 and stored in memory unity 204 based on the interactions of each node with each other and with message transactions. Similarly, the processor 202 can import the expertise information based on the interaction of each node with other nodes. The expertise information of the plurality of nodes 106 in the distributed network 104 is updated by the user regularly. Assuming an event occurred at geographic location Bangalore, the processor 202 captures expertise information as a tuple consisting of Namespace: Label: Value
Geography: Bangalore: (+n),
Geography: Karnataka: (+m)
Zip code: 560001: (+1),
Latitude: 12° 58′ N: (+o),
Longitude: 77° 38′ E: (+p).

When the events repeats, the expertise information if already exists, is updated. If the expertise element is not present, new expertise information is created.

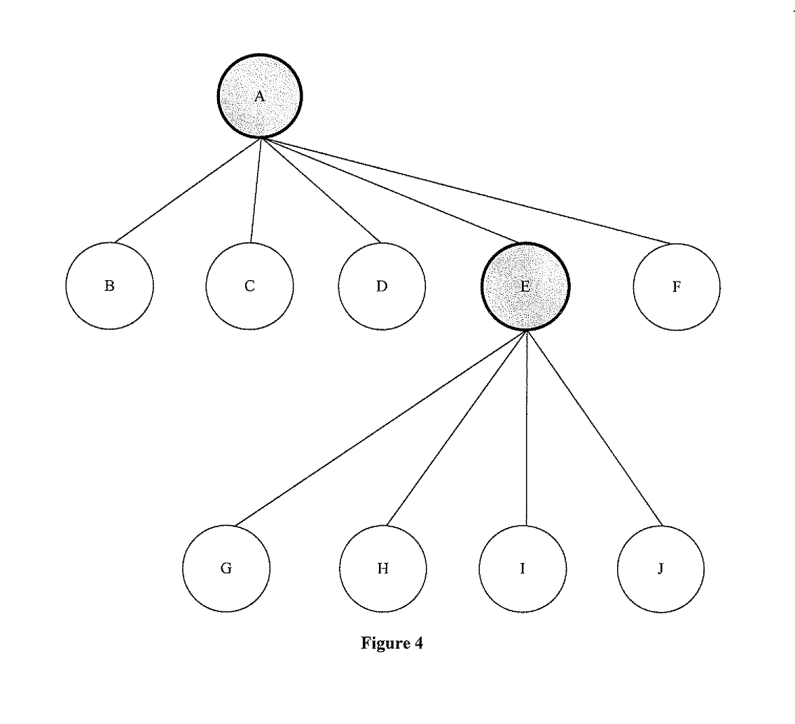

At step 304, a network power of each of the node from the plurality of nodes (106a, 106b, 106c and 106d) is computed by the processor 202. Computing the network power of the node is based on the plurality of nodes 106 connected to the node. FIG. 4 illustrates a network power the node in the distributed network in accordance with an embodiment of the present disclosure. During the registration or configuration, a node list down other nodes reachable through it based on the expertise information. For example, when the node is a person connected to the server 102, the contacts information e.g. email address, phone number of other nodes reachable through it are listed down. An address book from external email applications, phone books and social contacts from other social network servers 208 can also be imported. Therefore, the initial network power is sum of the expertise information of nodes reachable through the newly configured or registered node.

In the illustrated FIG. 4, the plurality of nodes 106 (106a, 106b, 106c and 106d) are A, B, C, D, E, F, G, H, I and J. The network power is based on how well the node accesses or extracts or uses the expertise information of other nodes in the distributed network 104 for performing one or more transactions. In an embodiment, the one or more transaction includes but not limited to request for a job, request for finding a right candidate, request for finding a full or partial answer to a query, request for improving previously found knowledge, request for recommendations, request for directions and other like recommendations and requirements. The one or more transactions can be initiated by either server 102 or any one of the plurality of nodes A, B, C, D, E, F, G, H, I and J. For example, computing the network power of the node A is based on the number of other nodes and expertise information of nodes such as B, C, D, E, F, G, H, I and J connected to the node A either directly or indirectly so that there exists the peer-peer network environment for performing one or more transactions through node A. Particularly, the node A is connected to nodes B, C, D, E and F directly so that one or more transactions can be performed through node A to its connected nodes B, C, D, E and F, therefore the network power of the node A is based on the nodes B, C, D, E and F. Similarly, if node E is connected to nodes such as G, H, I and J which are connected to node A indirectly, then overall network power of the node A in the peer-peer network environment, connected implicitly nodes G, H, I and J, is computed based on the nodes E, G, H, I and J and network power of E is based on the nodes A, G, H, I and J. For example, the server 102 can initiate posting job hiring requirements to the node A which is based on the expertise information of node A partially or fully satisfying the descriptions of the job hiring requirements. The node A can recommend or forward the job hiring requirements to one or more of its connected nodes like B, C, D, E and F which is based on their reputation information for finding a candidate or recommending a candidate in their network there by satisfying the descriptions of the job hiring requirements. In turn node E, satisfying the description of the job hiring requirements partially, can recommend or forward the job hiring requirement to one or more of its other connected nodes like G, H, T and J until the descriptions of the job hiring requirements is satisfied fully and a candidate is found. The node E can recommend the job hiring requirements, based on the reputation information of its directly connected nodes like G, H, I, and J.

At step 306, a contribution score of the node from the plurality of nodes (A, B, C, D, E, F, G, H, I and J) is measured by the processor 202. The contribution score measures the demonstrated intent of a node to contribute towards finding a response to one or more transactions in the distributed network 104. The contribution score is based on how well a node in the distributed network 104 interacts with other nodes and receives a reply or responses for a query message based on the expertise information to complete a transaction successfully. During the registration or configuration, the contribution of the node is listed down. For example, when the node is a person connected to the server 102, the contribution of the node achieved through or by the node in the past is listed down. This can also be imported from other external sources such question and answer forums, interest forums and other networks, where this node has demonstrated one or more counts of contribution to other nodes. These contributions demonstrate the nodes expertise as well as intent to share the expertise. The transactions performed through either providing a query message or the response or both. The contribution of the node can be imported from the social network servers 102. The initial contribution score is sum of all the contributions for complete a transaction successfully based on the expertise information.

For example, contribution score of node A is measured based on including but not limited on, kind of transactions with other nodes B, C, D, E and F and the responses the node A received from other nodes B, C, D, E and F based on the expertise information satisfying the query message fully or partially. Similarly, the contribution score of node E depends on interactions or transactions with other nodes A, G, H, I and J based on the expertise information satisfying the query message fully or partially. For example, node A can offer a job hiring requirements which is the query message to nodes B, C, D, E and F based on the expertise information satisfying the query message fully or partially and node E can offer the job hiring requirements to nodes like G, H, I and J. If the node A receives a reply or response on accepting the job hiring requirements from any one of other nodes B, C, D, E and F then the response received is included in measuring the contribution score of the node 106a.

At step 308, a reputation score of the node is determined using at least one of the acquired expertise information, the computed network power and the measured contribution score for extracting knowledge relating to the node in the distributed network 104. For example, the reputation score of node 106a is determined using the expertise information, its network power and its contribution score towards the one or more transactions. Additionally, a node can override the recommendation provided by one of the nodes or the processor 202 and select a different set of nodes to perform the one or more transactions and vice versa. When the recommendation is bypassed, the processor 202 records the deviation. When a full or partial response is obtained from the deviated path, processor 202 updates the expertise, network power and contribution score appropriately to reflect the deviation, so that the new information can be used for future reputation computation.

The expertise information acquired at step 302, the network power computed at step 304, the contribution score measured at step 306 and the reputation score determined at step 308 are stored in the memory unit 204 which is coupled to the processor 202.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, where features or aspects of the disclosure are described in terms of Markush groups, those skilled in the art will recognize that the disclosure is also thereby described in terms of any individual member or subgroup of members of the Markush group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Reference Table:

| Reference Numerals | Description |
|---|---|
| Server | 102 |
| Distributed Network | 104 |
| Plurality of nodes | 106 (106a, 106b, 106c, 106d) |
| Processor | 202 |
| Memory Unit | 204 |
| Computing Device | 206 (206a, 206b, 206c, 206d) |
| Social Network Servers | 208a, 208b |

We claim:

1. A method of extracting knowledge relating to a node from a plurality of nodes in a distributed network, said method comprising:
acquiring, by a processor, an expertise information of each of the plurality of nodes connected to the distributed network, wherein the expertise information is acquired by a mode comprising at least one of inputting, importing and learning by the plurality of nodes;
computing a network power of a node from the plurality of nodes by the processor based on the plurality of nodes connected to the node, wherein the network power is based on the expertise information of the plurality of nodes connected to the node;
measuring a contribution score of the node from the plurality of nodes, wherein the contribution score is based on role of the node towards one or more transactions in the distributed network; and
determining a reputation score of the node using at least one of the acquired expertise information, the computed network power and the measured contribution score for extracting knowledge relating to the node in the distributed network.

2. The method as claimed in claim 1, wherein the expertise information of the plurality of nodes is acquired from at least one social network server connected to the distributed network.

3. The method as claimed in claim 1, wherein the expertise information of the plurality of nodes is selected from a group comprising name, social contacts, address, qualifications, education, events, activities, interests, designations, type or class of messages transacted and one or more of the parameters directly or indirectly associated with each of the messages.

4. The method as claimed in claim 1, wherein the expertise information of the plurality of nodes is updated at a predefined interval of time.

5. The method as claimed in claim 1, wherein the one or more transactions is selected from a group comprising of request for a job, request for finding a right candidate, request for finding a full or partial answer to a query, request for improving previously found knowledge, request for recommendations, request for directions and other like recommendations.

6. A system for extracting knowledge relating to a node from a plurality of nodes in a distributed network, said system comprising:
a processor configured in a server to:
acquire an expertise information of each of the plurality of nodes connected to the distributed network, wherein the expertise information is inputted by the plurality of nodes;
compute a network power of a node from the plurality of nodes based on the plurality of nodes connected to the node, wherein the network power is based on the expertise information of the plurality of nodes connected to the node;
measure a contribution score of the node from the plurality of nodes, wherein the contribution score is based on role of the node towards one or more transactions in the distributed network; and
determine a reputation score of the node using at least one of the acquired expertise information, the computed network power and the measured contribution score for extracting knowledge relating to the node in the distributed network; and
a memory unit, coupled to the processor, configured to store the acquired expertise information, computed network power, measured contribution score and the determined reputation score.

7. The system as claimed in claim 6, wherein each of the plurality of nodes is associated with a computing device, said computing device is configured to receive the expertise information inputted by the plurality of nodes.
